(19) United States
(12) Patent Application Publication
(10) Pub. No.: US 2007/0162265 A1
(43) Pub. Date: Jul. 12, 2007

(54) Method and apparatus for automated simulation and design of corneal refractive procedures

(76) Inventor: Gary W. Hall, Tavernier, FL (US)

Correspondence Address: MICHAEL WINFIELD GOLTRY, 4000 N. CENTRAL AVENUE, SUITE 1220, PHOENIX, AZ, 85012, US

(21) Appl. No.: 11/724,868

(22) Filed: Mar. 16, 2007

Related U.S. Application Data
(63) Continuation of application No. 09/740,341, filed on Dec. 18, 2000, now abandoned.

(51) Int. Cl. G06G 7/48

(52) U.S. Cl. 703/3

(57) ABSTRACT

A technique for automated design of a corneal surgical procedure includes topographical measurements of a patient's eye to obtain corneal surface topography. Conventional techniques are used to obtain the thickness of the cornea and the intraocular pressure. The topographical information is interpolated and extrapolated to fit the nodes of a finite element analysis model of the eye, which is then analyzed to predict the initial state of strain of the eye and obtain pre-operative curvatures of the cornea. Insertion and thermal shrinkage data constituting the “initial” surgical plan is incorporated into the finite element analysis model. A new analysis then is performed to simulate resulting deformations, stresses, strains, and curvatures of the eye. They are compared to the original values thereof and to the vision objective. If necessary, the surgical plan is modified, and the resulting new insertion or thermal shrinkage date is entered into the model and the analysis is repeated. This procedure is repeated until the vision objectives are met.

### FIELD OF THE INVENTION

The present invention relates to systems and techniques for mathematically modeling a human eye using calculated strain values for a human eye and using a mathematical model to simulate strain deformation of the eye by hypothetical incisions, excisions, ablations, or prosthetic insertions to arrive at an optimum surgical design by identifying the number, shape, location, length, and depth of the incisions, excisions, ablations, or of corneal prosthetic insertions required to obtain a uniform or near homogeneous strain pattern on the cornea.

### BACKGROUND

The present invention relates to systems and techniques for mathematically modeling a human eye using calculated strain values obtained from data measured from a human eye. The mathematical model of the present invention simulates the change in strain conditions of the cornea effected by a set of hypothetical incisions, excisions, ablations, or corneal prosthetic insertions. A near uniform strain pattern on the cornea is a critical end-point in the calculation used to arrive at an optimum surgical design for the number, shape, location, length, and depth of the incisions, excisions, ablations, or corneal prosthetic inserts used in a proposed operation. It should be understood that hereinafter, including in the claims, the term “incision,” which usually refers to a cut made by a scalpel, and the term “excision,” which usually refers to a cut made by a laser beam, are considered to be interchangeable and to have the same meaning.

Modern corneal refractive surgery originated with the work of Dr. Svyatoslav Fyodorov of Moscow and Dr. Jose Barraquer of Bogota, Columbia. Subsequently, various surgical techniques have been developed to alter the curvature of the cornea to correct refractive errors. The various techniques include incisional keratotomy using diamond blades, excisional keratotomy using laser beams to photo-disrupt molecules and ablate tissue in a linear pattern, ablative keratectomy or photo-refractive keratectomy using laser beams to remove larger areas of corneal tissue, mechanical removal and reshaping of corneal tissue (keratomileusis), and implantation of human or synthetic materials (corneal prosthetics) into the corneal stroma. All of the known procedures alter central corneal curvature by changing the structure of the cornea. Additionally, because the central corneal curvature is changed, any strain relationships within the cornea are also changed by these procedures. All such refractive procedures are characterized by difficulty in predicting both the immediate and long term results, because of errors in calculations of pre-surgical measurements, failure to precisely implement the planned surgical techniques, and biological variances which affect immediate and long term results.

The cornea traditionally has been treated as a spherocylindrical lens, assuming that the radius of each individual meridian from the corneal apex to the corneal periphery is uniform. Prior methodologies tend to use an approximation to the topographic information of the cornea to determine the refractive power of the eye. In one known procedure, circular mires (reflected light images from the cornea conventionally used to mathematically calculate corneal curvature) are reflected from the corneal surface, and the difference between a given point on the mire and an adjacent mire is measured. A semi-quantitative estimate of the surface curvature is obtained by comparing this measurement with the values obtained using spheres of various radii. Prior mathematical models use a variety of approximations such as a simplified form of the corneal surface (e.g., spherical) or assume a symmetrical cornea (leading to a quarter model or an axisymmetric model) or use simplified material properties (e.g., isotropic), or assume small deformations or displacements, or do not consider clinically obtained data in the construction of the mathematical model. These models, by implicitly assuming uniform strain relationships in the cornea, do not accurately model any real strain relationships felt by the cornea.

One prior art is the article “On the Computer-Aided and Optimal Design of Keratorefractive Surgery,” by Steven A. Velinsky and Michael R. Bryant, published in Volume 8, page 173 of “Refractive and Corneal Surgery,” March/April 1992. This article describes a computer-aided surgical design methodology, proposing that it could be an effective surgical design aid for the refractive surgeon, wherein the surgeon could choose constraints on surgical parameters such as minimum optical zone size, maximum depth of cut, etc., measure the patient's corneal topography, refractive error and possible other ocular parameters, and then review the computed results. The article refers to several mathematical models described in the literature, and how such mathematical models might be helpful. However, the article fails to disclose any particular adequate mathematical model of the corneal strain relationships or any specific recommendation of surgical design that has been validated with clinical data.

Prior keratotomy procedures often are based on the experiential use of nomograms indicating appropriate surgical designs for a particular patient based on age, sex, refractive error, and intraocular pressure. These procedures do not account for the actual strain relationships in the cornea and frequently result in large amounts of under-correction or over-correction.

Finite Element Analysis (FEA) is a known mathematically based numerical tool that has been used to solve a variety of problems that are described by partial differential or integral equations. This technique has been used primarily in the area of solid mechanics, fluid mechanics, heat transfer, electromagnetics, acoustics, and biomechanics, including designing remedial techniques being developed for the human eye, to model internal structure and stresses in relation to various configurations of intraocular devices and corneal implants, as described in “Intraocular Lens Design With MSC/pal,” by A. D. Franzone and V. M. Ghazarian in 1985 at the MSC/NASTRAN User's Conference in Pasadena, Calif., and in “Corneal Curvature Change Due to Structural Alternation by Radial Keratotomy,” by Huang Bisarnsin, Schachar, and Black in Volume 110, pages 249-253, 1988 in the ASME Journal of Biomedical Engineering. Also see “Reduction of Corneal Astigmatism at Cataract Surgery,” by Hall, Campion, Sorenson, and Monthofer, Volume 17, pages 407-414, July 1991 in the Journal of Cataract Refractive Surgery.

There still is an current and continuing need for an improved system for accurately predicting outcomes of hypothetical surgical procedures on the cornea to aid in the design of minimally invasive corneal surgery. There is a still unmet need for a totally automated way of determining an optimal design of a surgical plan for incisional, excisional, ablative, or insertive keratotomy surgery to meet predetermined visual objectives with minimum invasiveness and minimum optical distortion. Further, it would be desirable to provide a technique for designing a multi-focal cornea that is similar to a gradient bifocal for patients that have presbyopia. It would be desirable to have an accurate mathematical model of the cornea for use in developing new surgical procedures without experimenting on live corneas.

### SUMMARY OF THE INVENTION

Accordingly, it is an object of the invention to provide a minimally invasive surgical procedure for corneal surgery for a human eye to achieve predetermined modified characteristics of that eye.

It is another object of the invention to provide a system and method that result in improved predictability of outcomes of corneal surgery.

It is another object of the invention to provide an improved method and apparatus for design of optical surgery that minimizes invasiveness of the surgical procedure.

It is another object of the invention to provide a method and apparatus for surgical design that results in reduction or elimination of postoperative irregular astigmatism.

It is another object of the invention to provide an improved apparatus and method for surgical design which results in reduced multi-focal imaging of the central cornea, thereby enhancing contrast sensitivity and improving vision under low light illumination conditions.

It is another object of the invention to provide an improved finite element analysis model of the human eye, including back-calculation of values of strain properties of the cornea and sclera, which incorporate the calculated strain properties of that eye and more accurately predict deformations of the cornea due to a hypothetical group of modeled incisions and/or excisions and/or ablation and/or insertions than has been achieved in the prior art.

It is another object of the invention to provide a system and method for providing an optimal surgical design for a human eye to achieve desired optical characteristics thereof.

It is another object of the invention to reduce the likelihood of postoperative complications in the eye including, but not limited to over-correction or under-correction of pre-existing refractive errors.

It is another object of the invention to provide a “training tool” or “surgery simulator” for surgeons who need to gain experience with corneal refractive surgery.

It is another object of the invention to provide a device for designing new surgical procedures without the need for experimentation on live human beings.

Briefly described, and in accordance with one embodiment thereof, the invention provides a system for simulating deformation of a cornea as a result of corneal incisions, excisions, ablations, and insertions in order to effectuate automated “surgical design” of a patient's eye in response to calculated strain conditions of the patient's eye. A finite element analysis (FEA) model of the eye is constructed. Measured x,y,z coordinate data are interpolated and extrapolated to generate “nearest-fix” x,y,z, coordinates for the nodes of the finite element analysis mode. Measured thicknesses of the eye are assigned to each element of the finite element model. Pre-operative values of curvature of the cornea are computed. In one embodiment of the invention, strain property values are “back-computed” from measured stress values of corneal deformations at different pressure loads. An initial estimated surgical plan, including a number of incisions, locations of incisions, incision orientations, incision depth, incision lengths, insert sizes, insert shapes, and insert locations is introduced into the shell finite element analysis model by introducing duplicate “nodes” and nonlinear springs along the initial hypothetical incisions. Or, ablations may be included in the estimated surgical plan introduced into the finite element analysis model by varying the thickness and/or material property constants of the elements in the ablated region. A geometrically and materially nonlinear finite element analysis then is performed by solving the equations representing the finite element analysis model in response to incremental increases in intraocular pressure until the final “equilibrium state” is reached. Postoperative curvatures of the cornea are computed and compared to pre-operative values and to vision objectives. If the vision objectives are not met, the surgical model is modified and the analysis is repeated. This procedure is continued until the vision objectives are met. In one embodiment, a boundary element analysis model is used instead of a finite element analysis model.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. § 112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWINGS

FIG. 1 is a block diagram illustrating the components used in the invention.

FIG. 2 is a basic flow chart useful in describing the method of the invention.

FIG. 3 is a block diagram of a subroutine executed in the course of executing block 35 of FIG. 2 to interpolate and extrapolate data in order to obtain the nodal coordinates of a finite element analysis model.

FIG. 4 is a block diagram of another subroutine executed in the course of executing block 35 or FIG. 2 to “construct” the finite element analysis model.

FIG. 5 is a three-dimensional diagram of the finite element mesh used in accordance with the present invention.

FIG. 6 is a partial side view illustrating both initial topography values of a portion of the cornea and final topography values resulting from simulated radial incisions and computed in accordance with the present invention.

FIG. 7 is a diagram useful in explaining how incisions are included in the finite element analysis model of the present invention.

FIG. 7A is a diagram useful in conjunction with FIG. 7 in explaining modeling of incisions.

FIG. 8 is a diagram useful in explaining a technique for cubic spline interpolation and extrapolation to create “smoothed” three-dimensional data points from raw data provided by a keratoscope.

FIG. 9 is a diagram useful in explaining automated back-calculation of the modulus of elasticity of the eye.

FIG. 10 is a diagram useful in explaining optimization of the surgical plan according to block 41 of FIG. 2.

### DESCRIPTION OF PREFERRED EMBODIMENTS

The present invention involves constructing a strain determining model of a human eye using a suitable three-dimensional finite element analysis (FEA) model that includes a mesh that generally corresponds to the shape of the human eye. The finite element mesh is obtained using back calculated strain data and translated into the nodal points of the FEA model and describes the strain characteristics of the human eye. The nodal points in a small region are connected to each other, to form a finite set of elements. The elements are connected to each other by means of sharing common nodes. The strain values at any particular region are obtained by back calculation and are applied to the elements. The “loading” of the finite element mesh structure is represented by the intraocular pressure, and the resistance of the structure to such applied “loading” is measured by the stiffness of the structure, which is computed on the basis of its geometry, boundary conditions, and its material properties, namely Poisson's ratio V, and Young's modulus E.

In the area of structural mechanics, finite element analysis formulations are usually based on the “principle of virtual work,” which is equivalent to invoking the stationary conditions of the total potential energy, Π, given by
Π=1/2∫ equation 1
where
ε=BZ (2)
and
σ=DE (3)

ε^{T} is the transpose of the strain vector, Z^{T} is the transpose of nodal displacement vector, and Z^{S}^{_{T}} is the transpose of the nodal displacement vectors on the surface. Z and Z^{S} are nodal displacement terms associated with nodal loads. In the above equations, the various symbols have the following meanings:

ε represents the strain vector

D represents the material matrix

Z represents the vector of nodal displacements

f^{β} represents the nodal body force vector

f^{δ} represents the nodal surface traction vector

dV represents differential volume

dS represents differential surface area

σ represents the stress vector

B represents a strain-displacement matrix

V represents volume

S represents surface area.

The first term on the right hand side of the equation (1) is the strain energy of the structure, and the second and third terms represent the total work accomplished by the external forces and body forces. The strain energy is a function of the strains and stresses that are related to each other via the material matrix D. The material properties that contribute to the material matrix D include the modulus of elasticity (Young's modulus) and Poisson's ratio. In a uniaxial state of stress, Poisson's ratio is defined as:
εₗₐₜ=−vε_{long}, (4)
where εₗₐₜ is the normal strain in the lateral direction and ε_{long} is the normal strain in the longitudinal direction. In a uniaxial state of stress, Young's modulus E is defined according to
σ_{zz}=Eε_{zz}, (5)
where σ_{zz} is the normal stress and σ_{zz} is the normal strain. The work accomplished is a function of the applied loads and surface tractions.

Using an assumed displacement field, the minimization of the total potential energy Π leads to the element equilibrium equations of the form
k_{n×n}xz_{n×1}=r_{n×1}, (6)

where the expression of
k_{n×n}=∫(1/v)B^{T}DBdV

is the element stiffness matrix, and Z_{n×1} is the vector of element nodal displacements r_{n'1} is the vector of element nodal forces. Since the entire structure is assumed to be in equilibrium, the assembly of the element equations leads to the structural equilibrium equations of the form
K_{N×N}xZ_{N×1}=R_{N×1} (7)

where K_{N×N} is the structural stiffness matrix, Z_{N×1} is the vector of nodal displacements and R_{N×1} is the vector of nodal forces. These algebraic equations are finally solved for Z in a variety of ways depending on whether the structural behavior is linear or nonlinear.

A commercially available finite element analysis program that effectively solves these equations after the appropriate values and boundary conditions have been assigned to the various nodes and the appropriate material properties have been assigned to the various elements defined by the connectivity of the nodes is called ABAQUS, available from HKS, Inc. of Providence, R.I. Creating the FEA model for purposes of the present invention simply involves inputting to the ABAQUS program the x, y, z coordinates for each node, inputting the strains that act on the nodes and/or elements, assigning appropriate boundary conditions to each node, defining the nodal connectivity that defines each element, and inputting the eye material properties and thickness or stiffness to each defined element along with other input data, such as whether the analysis is linear or non-linear, or the properties and definitions of the non-linear springs.

It should be noted that there are two popular approaches to solving finite element analysis problems, one being the above-described approach of minimizing total potential energy (or, the variational approach), the other being a method of weighted residuals which operates on partial differential equations defining the problem. The first approach is generally recognized to be simpler, and is implemented by the above ABAQUS program, but the invention could be implemented using the second approach.

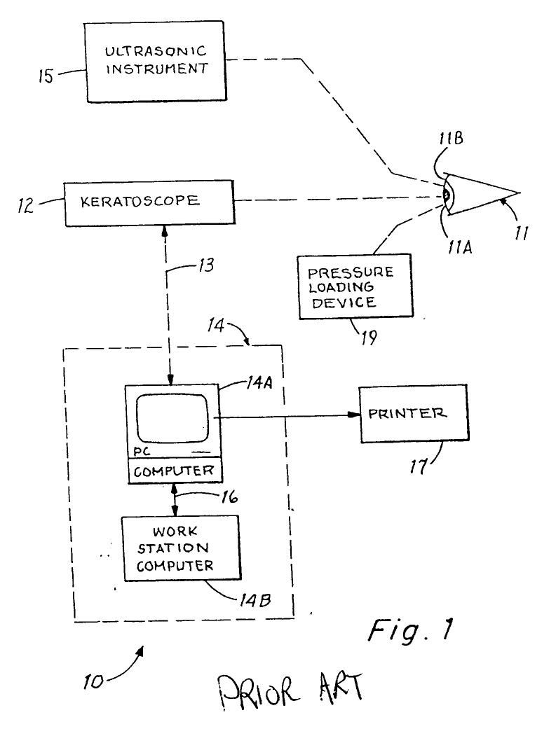

FIG. 1 shows an apparatus used in conjunction with the present invention. An ultrasonic instrument 15, such as a DGH packymetor, model DGH-2000 available from DGH Technology, Inc. of Frazier, Pa., is used to obtain the thickness and intraocular pressure of cornea 11A.

A corneal topographer 12, which can be a model TMS-1, manufactured by Computed Anatomy, 28 West 36βh Street, New York, N.Y., is utilized to measure the surface topography of cornea 11A. The resulting information is transferred by means of a floppy disk to a computer system 14. Alternatively, a digital data bus 13 could be provided to transfer topography information from corneal topographer 12 to computer system 14. A printer 17 is connected by a cable to the printer port of the computer system 14.

Thickness and interocular pressure measurements are made by ultrasonic instruments 15. This data then is used in the generation of the finite element model. However, it is possible to have this data transferred digitally, either by means of a floppy disk or a communication link, to the personal computer 14.

A conventional pressure loading device 19 is utilized to apply a precisely measurable force on a point of the sclera as far away as practical from the cornea, so that resulting changes on the elastic cornea as a result of the new loading can be measured. Then, in accordance with the present invention, the value of Young's modulus can be “back-calculated” in the manner subsequently described. Alternately, uniform pressure loading could be achieved by applying a sealed pressure chamber to the eye and increasing the gas pressure therein. Such uniform loading may have the advantage of providing less “noise” error in the measurements. A suitable pressure loading device 19 could be an opthalmo dynamometer, commercially available from Bailliart, of Germany.

To obtain an FEA model of the patient's eye, the measured topographical data is interpolated and extrapolated using the subsequently described cubic spline technique to provide a pre-established reduced number of nodal points of a finite element mesh, with nodal coordinates which are a “close fit” to the measured corneal surface. Values of the thickness of the cornea and sclera obtained from the data obtained from ultrasonic instrument 15 are assigned to the various finite elements of the FEA model. The FEA mesh then defines a continuous surface that accurately represents the pre-operative surface of the cornea, including any astigmatism that may be present.

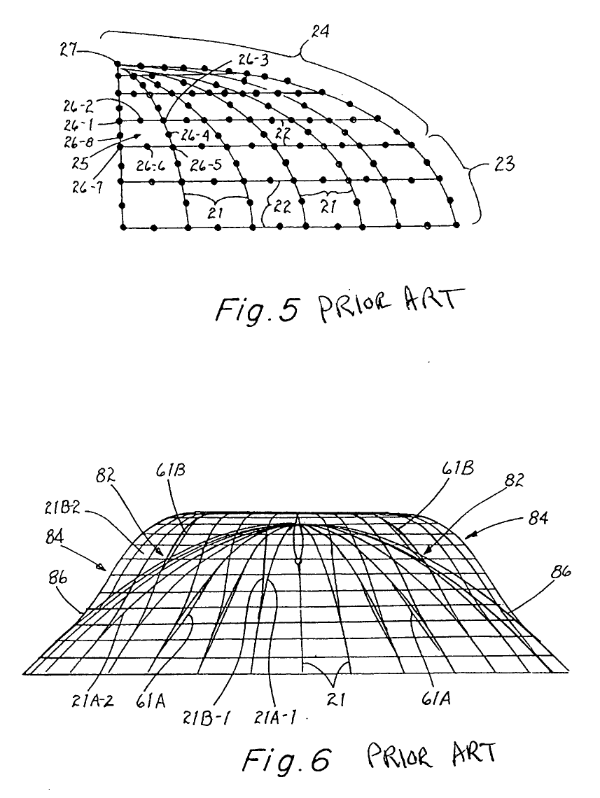

The curvatures of the surface then are computed at each node of the finite element analysis model. Surfaces of revolution are generated by revolving a plane curve, called the meridian, about an axis not necessarily intersecting the meridian. The meridian (defined by a radial line such as 21 in FIG. 5) is one of the principal sections and its curvature at any point is one of the principal curvatures k₁. (The principal curvatures are defined as the maximum and the minimum curvatures at a point on a surface.) The other orthogonal principal section is obtained by the intersection of the surface with a plane that is at right angles to the plane of the meridian and that also contains the normal. The second principal section has curvature k₂. If the equation of the meridian is written as r=f(z), then
K₁=−r″/[1+(r′)²]^{3/2}
and
k₂=[r[1+(r′)]^{3/2}]⁻¹

r′ and r″ being the first and second derivatives of r, respectively.

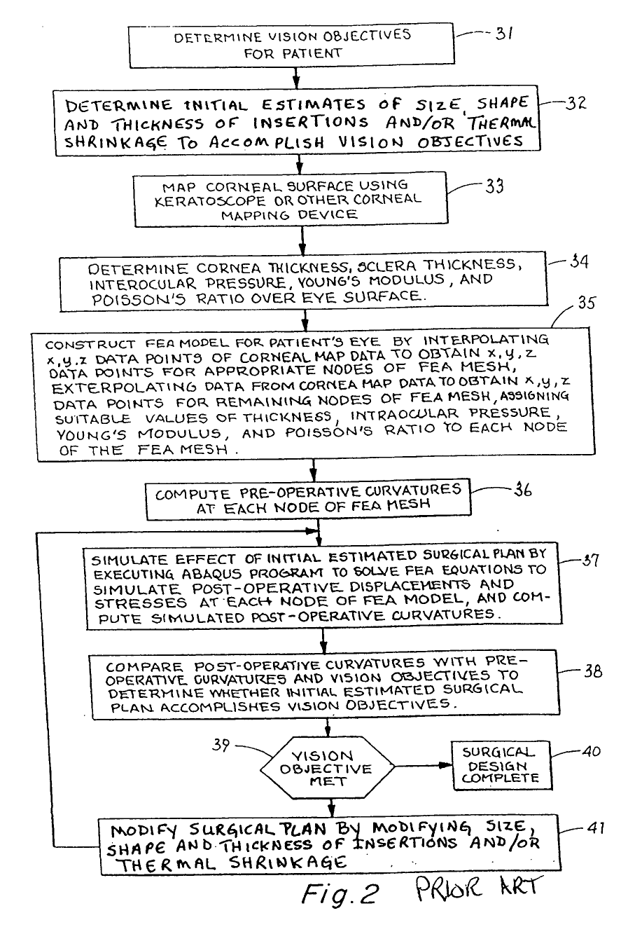

FIG. 2 is a flowchart useful in explaining the basic steps involved in use of the system shown in FIG. 1 to produce an optimum design for guiding surgery of a patient's eye. In block 31 of FIG. 2, the physician determines the “vision objectives” for the eye. The vision objectives can be specified as homogenous strain relationships throughout the cornea when the eye is in an accommodatively relaxed condition after completion of the surgery. The strains at various locations can be displayed, for example, by graded colors. These desired strain changes may be determined at nodal points on the cornea by back calculation and use of a spatially resolved refractometer. The vision objectives are selected to maximize the number of light rays that the eye focuses on the fovea for a given functional distance by creating a homogenous or uniform strain field in the cornea.

In block 32, the physician provides initial estimates of the number of incisions, ablations, insertions or thermal shrinkages required, their locations, the orientations of the various incisions, ablations, insertions or thermal shrinkages, the incision, ablation, or thermal shrinkage lengths, the incision, ablation, or thermal shrinkage depths, and the size and shape of the insertions needed in order to accomplish the vision objectives of block 31. As indicated in block 33, a corneal topographer 12 is used to obtain a topographic map of a portion of the eye. The TMS-1 corneal topographer mentioned above is capable of providing an x, y, z coordinate “map” that covers most of the cornea, producing a data file from which the x, y, z coordinates of approximately 7000 points can be obtained.

As indicated in block 34 of FIG. 2, the ultrasonic instrument 15 is used to provide measurements of the thickness of the cornea and the intraocular pressure. In the prototype system presently being implemented, typical values of Poisson's ratio and Young's modulus are used. Presently, Poisson's ratio values of 0.49 are used for both the cornea and sclera. Presently, values of Young's modulus equal to 2 10⁵ dynes per square millimeter are used for the cornea and 5 10⁵ dynes per square millimeter for the sclera.

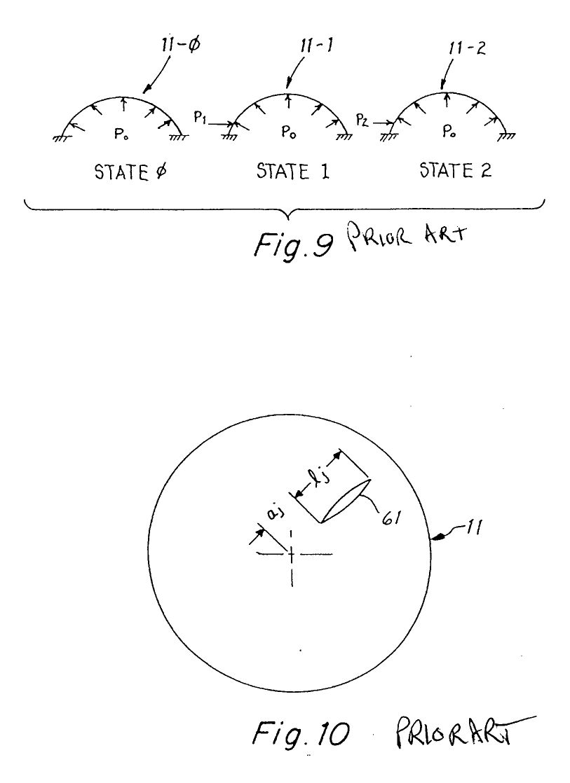

Preferably, Young's modulus, and ultimately elemental strain, is “back-calculated” on the basis of corneal topographical changes measured by using the corneal topographer 12 after varying a known force applied by pressure loading device 19 (FIG. 1) to the eye. The main objective of the back-calculation procedure is to determine as accurately as possible the modulus of elasticity for the cornea and the sclera, because it also is recognized that these values vary from patient to patient, and because it also is recognized that the modulus of elasticity is one of the most crucial parameters that influences the finite element analysis predictions. To describe the basic technique of the back-calculation procedure, refer to FIG. 9, which shows three assumed states, namely State 0 in which the cornea is relaxed, State 1 in which pressure loading device 19 applies point load P1 to the sclera of eye 11, and State 2 in which pressure loading device 19 applies point load P2 to the sclera. P0 is the intraocular pressure that is uniformly applied to the inner surface of the cornea and sclera. The values of the moduli of elasticity for the cornea and the sclera, respectively, are adjusted such that the z coordinates at selected nodes are close to the values actually measured for State 1 and State 2 by TMS-1 corneal topographer 12 with the two values of point loads P1 and P2 actually applied, respectively.

Let Zᵢⱼ be the observed z coordinate at a particular node i for a state j obtained using the above mentioned TMS-1 system. Let Zᵢⱼ be the computed z coordinate at a particular node i for the state j using the finite element analysis according to the present invention. The back-calculation problem then is to find the value of {E_{c}, Eₛ} to minimize the value of the expression for
f(E_{c},Eₛ)=ΣΣ(−1+Z₁^{j}+/Z₁^{j})

with the conditions
E_{C}^{L}≦E_{c}≦E_{C}^{U}
and
E_{S}≦^{L}Eₛ≦E_{S}^{U}

and where {E_{c},Eₛ} is the vector of design variables, f(E_{c},Eₛ) is the objective function, E_{c} is the modulus of elasticity of the cornea, Eₛ is the modulus of elasticity of the sclera, n is the number of points at which z displacements are to be computed, and the two inequality constraints represent the lower (L) and upper (U) bounds on the two design parameters. It should be appreciated that such a problem formulation falls under the category of a non-linear programming (NLP) problem, and can be solved using various non-linear programming techniques such as the “method of feasible directions”, or using a constrained least-squares technique. A commercially available program for solving such non-linear programming problems is the DOT (Design Optimization Tools) program, available from VMA, Inc. of Santa Barbara, Calif.

As indicated in block 35, an FEA model is “constructed” for the patient's eye by interpolating between the various 7000×, y, z coordinates of the corneal map produced by TMS-1 corneal topographer 12 to provide a smaller number of representative “smoothed” x, y, z values to be assigned to the various nodes of the FEA mesh shown in FIG. 5.

FIG. 5 shows one quadrant of the FEA mesh, the other three quadrants being substantially identical except for the nodal values assigned to the nodes thereof. The FEA mesh shown in FIG. 5 includes a plurality of equi-angularly spaced radial lines 21, each extending from a cornea center or apex 27 of cornea section 24 to the bottom of sclera section 23. In the FEA mesh actually used in a prototype of the invention under development, there are 32 such radial lines 21 and also 30 generally equally spaced circumferential lines 22. Each area such as 25 that is bounded by two adjacent radial lines and two adjacent circumferential lines 22 is an “element” of the FEA model. Each typical element 25 includes eight assigned “nodes”, such as nodes 26-1 . . . 26-8. The four corners of a typical element such as 25 share corner nodes 26-1, 3, 5, 7 with adjacent elements, and also share “midpoint” nodes 26-2, 4, 6, and 8 with corresponding midpoint nodes of adjacent elements. The nodes and the connectivity thereof which define the elements of the FEA mesh thus are illustrated in FIG. 5.

The values assigned to each node include its interpolated/extrapolated x, y, z coordinates and its boundary conditions, which are whether the node can or cannot undergo x, y, z displacements and rotations. The values assigned to each element in the FEA model include the thickness of the element, Young's modulus or modulus of elasticity, the shear modulus, the strain, and Poisson's ratio in the orthotropic directions, namely the xy, xz, and zx directions. Any external “loading” forces at each node also are assigned to that node. The orthotropic values of Poisson's ratio presently uses are ν_{xy}=0.0025, ν_{xz}=0.0025, and ν_{zx}=0.49. The value of shear modulus used is G_{yz}=6.71 10³ dynes per square millimeter.

The objective of the tasks in block 35 is three-fold. First, the total number of nodes, and thus the elements generated from them, should be a variable, so that the mesh sensitivity of the results can be studied while the operator is given the chance to use a coarse mesh for preliminary studies. Second, the nodal points generated should be compatible with the choice of element required. For example, eight-node shell elements are used in the present approach. However, the proposed system is able to generate any type of element required, such as a 27-node hexahedral three-dimensional element, a 6-node triangular shell element, or a 9-node shell element. Third, the nodes generated must be able to provide sufficient mesh refinement or density to achieve the needed resolution. A refined mesh in the regions of primary interest such as the optical zone is important since it can capture the stresses, strains and the variations of the displacements, and thus, the curvatures. The mesh refinement parameter is chosen by the operator as one of the variables to study for the regions of primary interest, such as the optical zone (i.e., the portion of the cornea central to the radial incisions), while the other regions such as the sclera are still incorporated in the model.

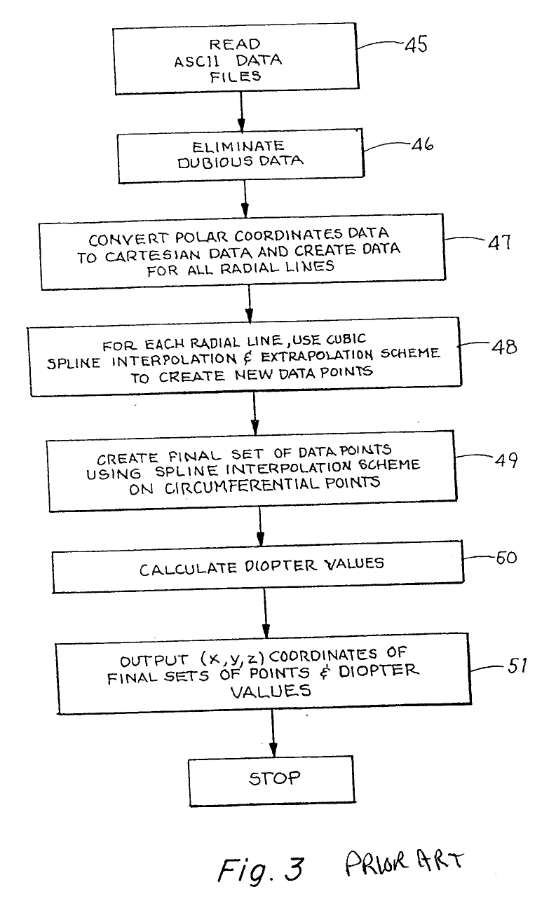

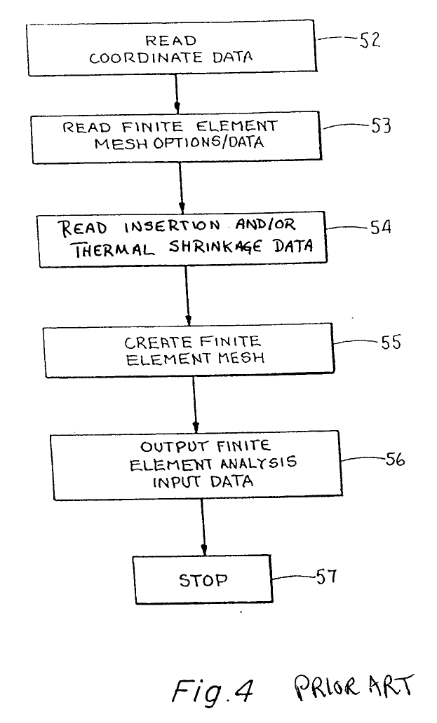

Some of the steps performed by computer 14 in accordance with block 35 of FIG. 2 are shown more specifically in FIGS. 3 and 4. As indicated in block 45 of FIG. 3, computer 14 reads the ASCII data files containing the above-mentioned 7000 coordinates of the corneal map produced by the TMS-1 corneal topographer 12. Due to the nature of the data collection, it is possible that some “noise” exists in the original data. The origin of the noise might be attributed to the inability of corneal topographer 12 to provide an exact determination of the coordinates, or the lack of existence of the coordinate value at an expected site. As indicated in block 46, a simple program scans the original data for elimination of such data points.

As indicated in block 47 of FIG. 3, the polar coordinate data supplied by the TMS-1 corneal topographer is converted into the above-mentioned 7000 x, y, z coordinates. Points which lie along the radial lines 21 of the FEA mesh shown in FIG. 5 are selected for use in the interpolation/extrapolation process described below.

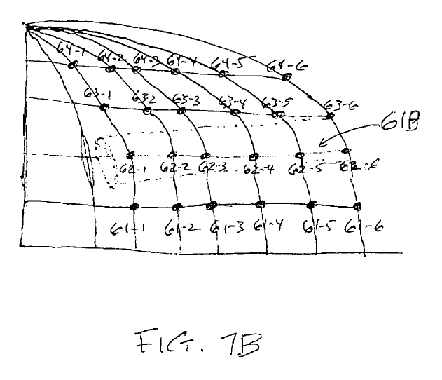

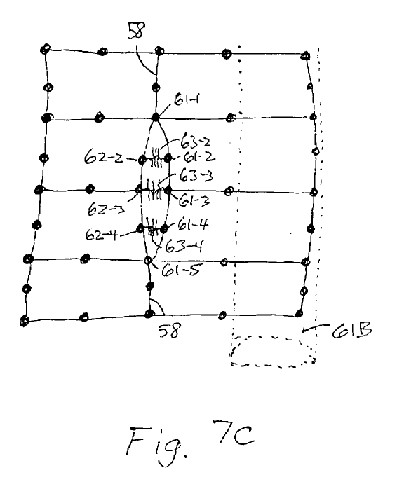

As indicated in block 48, the cubic spline interpolation and extrapolation procedure (described later with reference to the diagram of FIG. 8) is utilized to compute the intermediate x, y, z coordinates for each node of the FEA mesh lying on the pre-defined radial line 21 (FIG. 5). Then, as indicated in block 49 of FIG. 3, the program creates a final set of x, y, z coordinates for nodes that lie on the circumferential lines 22 of the FEA mesh (FIG. 5) using the cubic spline interpolation/extrapolation method. This step is necessary since data points that have the same radial coordinate do not necessarily have the same height or z value.

At this stage, as indicated in block 50 of FIG. 3, the initial or pre-surgery diopter values at the final setup points are computed. Once the radial lines 21 are “generated”, a series of nodes are selected at a specific height and used to obtain the circumferential nodes, i.e., the nodes which are on circumferential lines 22 “between” the radial lines 21. The x, y, z coordinates and diopter values of curvature at each node of the model then are output.

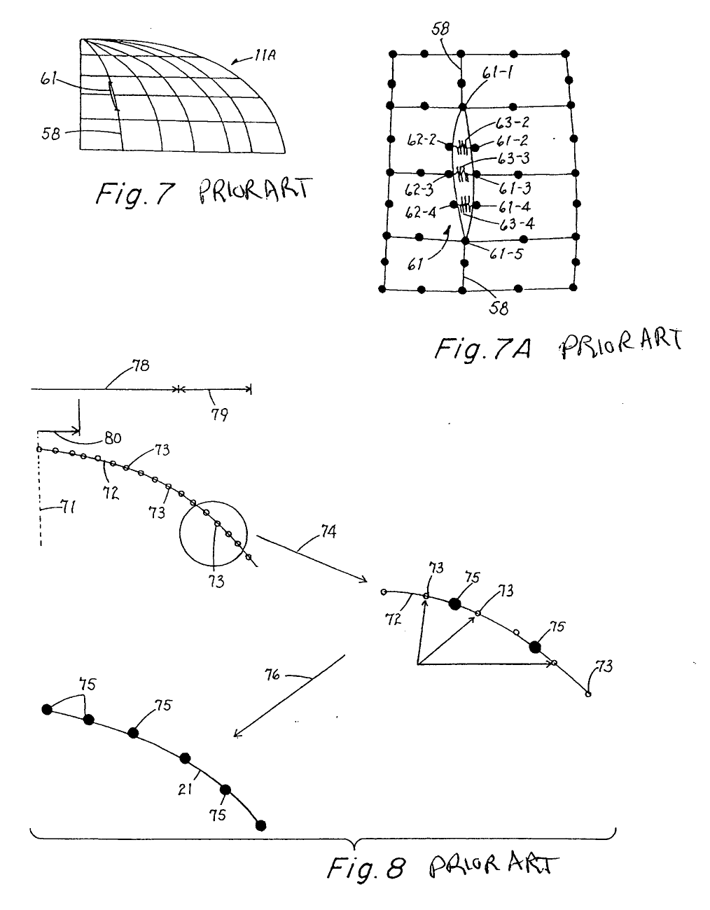

As indicated in block 52 the coordinate data files produced by block 51 of FIG. 3 are read. In block 53 the finite element mesh options/data are read. This includes the orthotropic material properties of the cornea and sclera, the nonlinear load-elongation curve data used by the “spring” elements (i.e., the insertion thickness or thermal shrinkage depth as subsequently described with reference to FIGS. 7 and 7A), the loading information (i.e., the intraocular pressure), and the boundary conditions (i.e., the connections of the bottom nodes of the sclera to a stationary reference). Then, the program reads the surgical data, as indicated in block 54, and goes to block 55 in which the FEA model is “created”, i.e., duplicate nodes, element connectivity and load-elongation data for the spring elements are created.

Finally, in block 56, the data files required for carrying out a geometric and materially nonlinear finite element analysis are created and output. In the present embodiment of the invention, the above-mentioned ABAQUS program is used as the finite element analysis program and is executed on the computer system 14.

Returning to FIG. 2, in block 36, pre-operative curvatures are completed in diopters at each node of the FEA model.

Then, in block 37, an initial (estimated) number of insertions or thermal shrinkages are “constructed” in the FEA model using the information established in block 32. It should be recognized that incisions and ablations or linear combinations of the entire above are included herein, but for simplicity, the following discussion will be limited to insertions and thermal shrinkages. FIGS. 7 and 7A illustrate how each such thermal shrinkage is modeled in accordance with the present invention. In FIG. 7, the FEA mesh 11A includes a thermal shrinkage 61 modeled along a radial line 58 of the FEA mesh, in which numerals 61-1,2,3,4,5 represent all nodes of the FEA mesh from one end of the modeled thermal shrinkage 61 to the other. The elasticity at these nodes, and their neighboring spring elements, are changed according to predetermined values corresponding to the changes caused by thermally induced shrinkage of the collagen fibers of the cornea. When thermal shrinkage of the collagen causes a stiffening of the corneal tissue, the elasticity is reduce; commensurately, when thermal shrinkage of the collagen causes a “loosening” of the corneal tissue, the elasticity is increased. The thermally induced shrinkages may be caused by laser heating, cauterizing wires, or the like.

These changed spring elements have nonlinear load-deflection curves. The nature of the curves is a function of the depth of thermal shrinkages and the material properties of the tissue through which the thermal shrinkage is made. The depth of the modeled thermal shrinkage 61 is represented by equations corresponding to the nonlinear elastic spring elements in FIG. 7A. When an FEA program is executed, the effect of the intraocular pressure is to cause the thermal shrinkage 61 to change an amount determined by the elastic spring constants assigned to the neighboring spring elements.

In another example FIGS. 7B and 7C illustrate how each such insertion is modeled in accordance with the present invention. In FIG. 7B, the FEA mesh 11A includes an insertion 61B modeled along several radial lines of the FEA mesh, in which numerals ______ represent all nodes of the FEA mesh impacted by the modeled insertion 61B. In this example, z value for the impacted nodes and the elastic constants are at the nodes, including their neighboring spring elements, are changed by the addition of the insert into the corneal tissue. The inclusion of the insert effectively stiffens the neighboring spring elements, similar to the effect of increasing pressure. The size, depth, and shape of the insert may be varied, as desired, and may be preferably designed to ultimately provide for a homogeneous strain relationship in the corneal tissue.

These changed spring elements have nonlinear load-deflection curves. The nature of the curves is a function of the size, depth, and shape of the insert and the material properties of the tissue through which the thermal shrinkage is made. The size, depth, and shape of the modeled insert 61B is represented by equations corresponding to the nonlinear elastic spring elements in FIG. 7C. When an FEA program is executed, the effect of the intraocular pressure is to that caused by the insert 61B.

The above-mentioned ABAQUS FEA program, when executed as indicated in block 37 of FIG. 2, computes the displacements at each node of the FEA model in response to the intraocular pressure.

The computed nodal x, y, z displacements are added to the corresponding pre-operative x, y, z values for each node, and the results are stored in a data file. If desired, the results can be displayed in, for example, the form illustrated in FIG. 6. Post-operative curvatures (computed in diopters) and corneal strains then are computed and displayed for each node based on the new nodal locations.

In FIG. 6, which shows a computer-printout produced by the system of FIG. 1, the measured pre-operative configuration of the eye surface is indicated by radial lines 82, and the computed post-operative configuration is indicated by radial lines 84. Numerals 21 generally indicate radial lines of the FEA model, as in FIG. 5. More specifically, numerals 21A-1 and 21A-2 designate radial lines of the pre-operative surface represented in the FEA model, and numerals 21B-1 and 21B-2 represent radial lines of the “computed” post-operative surface in the FEA model. Numerals 61A designate proposed radial incisions in the “measured” pre-operative surface, and numerals 61B designate the same incisions in the “computed” post-operative surface. (The individual circumferential lines of the computer printout of FIG. 6 are difficult to identify, but this does not prevent accurate interpretation of the effect of the proposed incisions on the curvature of the cornea.) Numeral 86 indicates the limbus.

As indicated in block 38, the post-operative curvatures and strains are then compared with the pre-operative curvatures and strain with their corresponding vision objectives established according to block 31 to determine whether the initial estimated surgical plan accomplished the vision objectives.

Then, as indicated in block 39, computer 14 determines if the strain boundary conditions along with the vision objectives are met. If the determination of decision block 39 is affirmative, the surgical design is complete, as indicated in label 40. Otherwise, however, the program executed by computer 14 goes to block 41, and an optimization technique, subsequently described with reference to FIG. 10, is utilized to modify the number of incisions, ablatoins, thermal shrinkages, and insert, their locations, orientations, lengths, depths, sizes, and shapes. The process then returns to block 37 and repeats until an affirmative determination is reached in decision block 39.

The technique for modifying and optimizing the surgical design according to block 41 can be understood with reference to FIG. 10. As indicated above, the vision objectives are to obtain prescribed curvature values at specific FEA nodal locations i on the cornea. As an example, assume the surgical plan includes the locations of the insertions and includes the location, size and shape of each insertion. The surgical optimization problem of block 41 then can e defined to be the problem of determining a value of {aⱼ,lⱼ,dⱼ} that minimizes the value of the expression
F(aⱼ,lⱼ,dⱼ)=Σ(−1+rᵢ/rᵢ)
with
aⱼ^{L}≦aⱼ≦Aⱼ^{U}
lⱼ^{L}≦Lⱼ≦Lⱼ^{U}
dⱼ^{L}≦dⱼ≦dⱼ^{U}

where {aⱼ,lⱼ,dⱼ} is the vector of design variables, f{aⱼ,lⱼ,dⱼ} is the objective function, aⱼ is the starting radial distance from the center of the finite element model, as shown in FIG. 10, lⱼ is the length of the insertion, dⱼ is the height of the insertion, j is the insertion number, rᵢ is the computed curvature value based on the results from the finite element analysis, rᵢ is the observed curvature, n is the number of points at which curvature computations are to be carried out, and the three above inequality constraints represent the lower (L) and upper (U) bounds on the three design parameters.

With this information, it is possible to include any parameter that influences the finite element model as a potential design variable, and any response or parameters related to the response computed by the finite element analysis as appearing in the objective functions or constraints. For example, the shape of the insertion, the number of different insertions, or the compressibility of a thickness of tissue can be design variables.

The foregoing problem formulation falls under the category of nonlinear programming problem. Those skilled in the art can readily solve such problems using nonlinear programming techniques utilizing commercially available nonlinear programming software, such as the previously mentioned DOT program.

FIG. 8 is useful in illustrating the application of cubic spline techniques referred to in block 48 of FIG. 2 to interpolate/extrapolate data from the nodal points of the FEA mesh from the data points obtained from TMS-1 corneal topographer 12. In FIG. 8, numeral 71 designates the z axis or a center line of the cornea passing through its apex, numeral 72 designates a radial line along which data points obtained from corneal topographer 12 lie, and numeral 73 designates various such measured data points. The extent of the cornea is indicated by arrow 78, and the extent of the sclera is indicated by arrow 79. The extent of the “optical zone” is indicated by arrow 80. As indicated above, the TMS-1 corneal topographer provides 7000 such data points 73. The first step of the cubic spline process takes such data points, as indicated by arrow 74, and “fits” each segment of radial line 72 between adjacent corneal topographer data points 73 to the equation
z=ax³+bx²+cx+d, 12

where z is a distance along center line 71, and x is distance in the horizontal direction from line 71 toward the base of the sclera. Equation 12 then is used to compute values of z for each value of x corresponding to a node of the FEA mesh (shown in FIG. 5) to obtain values z for each of the nodes of the FEA mesh along each radial line 21, as indicated by arrow 76 in FIG. 8. Values for the “midpoint” nodes such as 26-2 and 26-6 of FIG. 5 are obtained by interpolating adjacent nodal values of z on the same circumferential line 22. Most texts on numerical analysis disclose details on how to use the cubic spline technique, and various commercially available programs, such as IMSL, available from IMSL, Inc. of Houston, Tex., can be used.

A fixed boundary condition for the base of the sclera can be assigned. It has been found that the nature of the boundary conditions at the base of the sclera has only a small effect on the results of the finite element analysis of the cornea.

The above-described model was utilized to compute the strains and nodal deflections in a particular patient's eye based on measured topographical data extending outward approximately 8 millimeters from the center of a patient's eye. The measured data was extrapolated outward another 8 millimeters to approximate the topography of the remaining cornea.

The above-described FEA model can be used to pre-operatively design incisions, excisions or ablations, thermal shrinkages, and insertions into the cornea, resulting in great predictability of surgical outcome and thereby allowing minimum invasiveness to achieve the desired result with the least amount of surgical trauma to the cornea. Fewer operative and post-operative visits by the patient to the surgery clinic are likely as a result of the use of this procedure. Advantages of the improved surgical designs that result from the above-described invention include reduced multi-focal imaging of the central cornea, thereby enhancing contrast sensitivity and improving vision under low light illumination conditions. Reduction or elimination of post-operative irregular astigmatism is another benefit. Yet another benefit is minimization of side effects such as glare and fluctuation of vision associated with traditional incisional keratotomy. The described mathematical model will have other uses, such as allowing design of a bifocal corneal curvature to allow both near and distance vision for patients in the presbyopic stage of their lives. The model of the present invention also will allow development of new surgical techniques for correcting nearsightedness, farsightedness and astigmatism as a viable alternative to experimenting on live human corneas.

While the invention has been described with reference to several particular embodiments thereof, those skilled in the art will be able to make the various modifications to the described embodiments of the invention without departing from the true spirit and scope of the invention. It is intended that all combinations of elements and steps which perform substantially the same function in substantially the same way to achieve the same result are within the scope of the invention.

For example, keratoscopes or other cornea measurement devices than the TMS-1 device can be used. Non-radial incisions, such as T-shaped incisions for correcting astigmatism, can be readily modeled. Many variations of the finite element model are possible. In the two-dimensional shell finite element analysis model described above, the use of the nonlinear springs to model depths of incisions could be avoided by modeling elements around the proposed incision to have reduced thickness and/or different material properties, so that the incision region has reduced stiffness, and the computed deformations are essentially the same as if the nonlinear springs were to be used. For example, it is possible to use three-dimensional finite elements in lieu of the two-dimensional shell finite elements with assigned thickness parameters, and model the incisions directly, without having to use the nonlinear spring elements. Mathematical models other than a finite element analysis model can be used. For example, a boundary element analysis model could be used. As those skilled in the art know, the basic steps in the boundary element methods are very similar to those in the finite element methods. However, there are some basic differences. First, only the boundary is discretized, that is, the elements are “created” only on the boundary of the model, whereas in finite element analysis models the elements are “created” throughout the domain of the model. Second, the fundamental solution is used which satisfies the governing differential equation exactly. A fundamental solution is a function that satisfies the differential equation with zero right hand side (i.e., with body force set to zero) at every point of an infinite domain except at one point known as the source or load point at which the right hand side of the equation is infinite. Third, the solution in the interior of the model can be obtained selectively once the approximate solution on the boundary is computed. Although constant intraocular pressure has been assumed, non-constant intraocular pressure could be incorporated into the described technique. Although post-operative swelling has been assumed to not effect the eventual curvatures of the cornea, healing of the incision does effect the eventual curvature. The finite element analysis model can be adapted to model such healing effects and predict the final curvatures, strains, etc.

Additionally, p-finite elements, Raleigh-Ritz, mixed formulations, Reissner's Principal, all can be used to generate the finite element equations. These equations, then, can be used in the modeling method of the present invention.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

1. A computer-implemented method of simulating the corneal strain relationship produced by patient specific corneal deformation in response to an insertion of an insert in the cornea, comprising the steps of:
(a) measuring the topography of a portion of the patient's eye using a topography measuring device to produce patient specific x, y, z coordinates for a number of patient specific data points of the surface of the patient's eye;
(b) storing in a storage device a mathematical analysis model of the patient's eye, the model including a number of nodes, the connectivities of which define a plurality of elements;
(c) determining a value representing intraocular pressure in the patient's eye and assigning a strain value to each element;
(d) representing an insertion of an insert in the cornea, and thus a region of increased stiffness in the cornea in the mathematical analysis model by assigning new values to the topography of the portion of the patient's eye surrounding the insert corresponding to the size, shape, and thickness of the insert and a value of the modulus of elasticity to elements surrounding the insert computed from the value determined in step (c); and
(e) using the mathematical analysis model to compute new values of the patient specific x, y, z coordinates and therefrom, new strain relationships resulting from the insertion of the insert in the cornea at each of the nodes, respectively.

2. A computer-implemented method of simulating the corneal strain relationship produced by patient specific corneal deformation in response to an insertion of an insert in the cornea, comprising the steps of:
(a) measuring the topography of a portion of the patient's eye using a topography measuring device to produce patient specific x, y, z coordinates for a large number of patient specific data points of the surface of the patient's eye;
(b) storing in a storage device operably associated with a computer system for implementing the computer-implemented method, a mathematical analysis model of the patient's eye, the model including a number of nodes, the connectivities of which define a plurality of elements;
(c) determining a value representing intraocular pressure in the patient's eye and assigning a strain value to each element;
(d) representing an insertion of an insert in the cornea, and thus a region of increased stiffness in the cornea, in the mathematical analysis model by changing the z coordinate of the nodes surrounding the insert and representing the effect of the insert by means of a plurality of nonlinear spring elements each connecting an insertion-bounding node to an adjacent node, respectively each of the plurality of nonlinear spring elements having a load deflection curve based upon size, shape, and thickness of the insert and the value obtained from step (c); and
(e) using the mathematical analysis model to compute new values of the patient specific x, y, z coordinates and therefrom, new strain relationships resulting from the insertion of the insert in the cornea at each of the nodes, respectively.

3. The computer-implemented method of claim 2 including establishing at least one vision objective for the patient's eye, wherein step (e) includes comparing the simulated strain relationship within the cornea with a vision objective to determine if the insertion of the insert in the cornea results in the vision objective being met, and, if the vision objective is not met, modifying the insertion of the insert in the cornea and/or adding another changes to the cornea in the mathematical analysis model and repeating step (e) to determine if the at least one vision objective is met.

4. A computer-implemented method of simulating the corneal strain relationship produced by patient specific corneal deformation in response to an insertion of an insert in the cornea, comprising the steps of:
(a) measuring the topography of a portion of the patient's eye using a topography measuring device to produce patient specific x, y, z coordinates for a number of patient specific data points of the surface of the patient's eye;
(b) storing in a storage device a mathematical analysis model of the patient's eye, the model including a predetermined number of nodes, the connectivities of which define a plurality of elements;
(c) determining a value representing intraocular pressure in the patient's eye and assigning a strain value to each element;
(d) representing an insertion of an insert in the cornea, and thus a region of increased stiffness in the cornea, in the mathematical analysis model by assigning at least one of reduced values of the thickness and a reduced value of the modulus of elasticity to elements corresponding to the insertion of the insert in the cornea; and
(e) using the mathematical analysis model to compute new values of the patient specific x, y, z coordinates and therefrom, new strain relationships resulting from the insertion of the insert in the cornea at each of the nodes, respectively.

5. The computer-implemented method of claim 4 including establishing at least one vision objective for the patient's eye, wherein step (e) includes comparing the simulated deformation of the cornea with the vision objective to determine if the insertion of the insert in the cornea results in the vision objective being met, and, if the vision objective is not met, modifying the insertion of the insert in the cornea in the mathematical analysis model and repeating step (e) to determine if the at least one vision objective is met.

6. A computer-implemented method of simulating the corneal strain relationship produced by patient specific corneal deformation in response to an insertion of an insert in the cornea, comprising the steps of:
(a) measuring the topography of at least a portion of the patient's eye using a topography measuring device to produce patient specific x, y, z coordinates for each of a plurality of patient specific data points of a surface of the patient's eye;
(b) storing in a storage device associated with the computer system a finite element analysis model of the patient's eye, the finite element analysis model including a number of nodes, the connectivities of which define a plurality of elements;
(c) operating a processing device which interfaces with the storage device to interpolate between and extrapolate beyond the patient specific data points to obtain a reduced number of patient specific x, y, z coordinates that correspond to nodes of the finite element analysis model, respectively, and assigning the reduced number of patient specific x, y, z coordinates to the various nodes, respectively;
(d) determining a value representing intraocular pressure in the patient's eye and assigning a strain value to each element;
(e) representing a first insertion of an insert in the cornea, and thus a region of increased stiffness in the cornea in the finite element analysis model by representing the thickness, size, and location of the insert by changing the z coordinate of elements surrounding the insert and representing the change in the corneal elasticity caused by the first insertion of the insert in the cornea by means of a plurality of nonlinear spring elements having load deflection curves based upon the at least one material property value determined in step (d) and insert thickness, each nonlinear spring element connecting an insert affected node to an adjacent node, respectively, by shell modeling;
(f) using the finite element analysis model to compute at each of the nodes, new values of the patient specific x, y, z coordinates and therefrom, new strain relationships resulting from the insertion of the insert in the cornea at each of the nodes; and
(g) displaying the strain relationships at the nodes having the computed patient specific x, y, z coordinates to show the simulated resulting deformation of the cornea.

7. The computer-implemented method of claim 1 including establishing at least one vision objective for the patient's eye, said at least one vision objective being selected from the group consisting of visual acuity, duration of treatment, absence of side effects, low light vision, astigmatism, contrast and depth perception, and storing vision objective information in the storage device, wherein step (f) includes comparing the simulated deformation of the cornea with the vision objective information to determine if the insertion of the insert in the cornea results in the vision objective being met.

8. The computer-implemented method of claim 7 including, if the vision objective is not met, modifying a first insertion of the insert in the cornea and/or adding a second insertion of another insert in the cornea in a finite element analysis model similar to the first insertion of the insert in the cornea, and repeating step (f) to determine if the vision objective is met.

9. The method of claim 8 wherein step (c) includes executing the finite element analysis model so as to homogenize the strain relationship of the surface of the patient's eye represented in the finite element analysis model.

10. The computer-implemented method of claim 9 including measuring the thickness of various points of the cornea and/or sclera and assigning values of the measured thicknesses to each element of the finite element analysis model, respectively, before step (f).

11. The computer-implemented method of claim 9 including modeling a thermal shrinkage of the cornea in the finite element analysis model by assigning at least one of reduced values of the thickness and a reduced value of the modulus of elasticity to elements corresponding to the thermally shrunk portion of the cornea, respectively.

12. The computer-implemented method of claim 9 wherein the insert of the first insertion is a torous shaped insert.

13. The computer-implemented method of claim 9 including assigning values of material constants of the eye, including Poisson's ratio, modulus of elasticity, and shear modulus, to each element of the finite element analysis model.

14. The computer-implemented method of claim 8 wherein the modifying includes executing a nonlinear programming computer program to determine how much to modify the number of inserts, the shapes of the inserts, the thickness of the insertions inserts and the locations of the inserts.

15. The computer-implemented method of claim 7 wherein establishing the at least one vision objective includes providing an initial set of surface curvatures for the cornea, the computer-implemented method including computing simulated post-operative curvatures from the new values of patient specific x, y, z coordinates computed in step (f) and comparing the simulated post-operative curvatures with the surface curvatures of the initial set to determine if the at least one vision objective is met.

16. The method of claim 7 wherein each element of the finite element analysis model is an eight-node element, and wherein a boundary condition of the finite element analysis model is that a base portion of the finite element analysis model is stationary.

17. The method of claim 8 including assigning substantially different measured values of strain to elements of cornea portions and sclera portions of the finite element analysis model.

18. The computer-implemented method of claim 1 wherein step (c) includes executing a cubic spline computer program to obtain the reduced number of patient specific x, y, z coordinates according to an equation z=ax³+bx²+cx+d which has been fit to the measured patient specific data points of step (a), x being a distance from an apex axis of the patient's eye.

19. The computer-implemented method of claim 8 including selecting at least one vision objective for each patient which produces a simulated multi-focal configuration of the cornea.

20. A computer-implemented method of simulating patient specific corneal deformation as a result of an insertion of an insert in the cornea of a patient's eye, comprising the steps of:
(a) measuring the topography of a portion of the patient's eye using a topography measuring device to produce patient specific x, y, z coordinates for a number of patient specific data points of a surface of the patient's eye;
(b) storing in a storage device associated with a computer system used for the computer-implemented method, a finite element analysis model of the patient's eye, the finite element analysis model including a predetermined number of nodes, the connectivities of which define a plurality of elements;
(c) operating a processing device operatively associated with the computer system to interpolate between and extrapolate beyond the patient specific data points to obtain a reduced number of patient specific x, y, z coordinates that correspond to nodes of the finite element analysis model, respectively, and assigning the x, y, z coordinates to the various nodes, respectively;
(d) determining a value representing intraocular pressure in the patient's eye and assigning a strain value to each element;
(e) representing an insertion of an insert in the cornea, and thus a region of increased stiffness in the cornea, in the mathematical analysis model by assigning at least one of reduced values of the thickness and a reduced value of the modulus of elasticity to elements corresponding to the insertion of the insert in the cornea, respectively;
(f) using the finite element analysis model, computing new values of the patient specific x, y, z coordinates at each of the nodes to simulate deformation of the cornea resulting from the proposed insertion of the insert in the cornea; and
(g) operating the processing device to display the computed patient specific x, y, z coordinates to show the simulated deformation of the cornea.

21. A computer-implemented method of determining change of a cornea of a patient's eye as a result of an of an insert in the cornea, the computer-implemented method including the steps of:
(a) storing in a storage device operatively associated with a computer system for implementing the computer-implemented method, a finite element analysis model of a patient's eye, the finite element analysis model including a number of nodes, the connectivities of which define a plurality of elements;
(b) applying a known external pressure to the patient's eye and then measuring the topography of a portion of the patient's eye using a topography measuring device to produce patient specific x, y, z coordinates for a number of patient specific data points of the pressure-deformed surface of the patient's eye and then remapping the topography by backcalculating the data;
(c) operating a processing device operatively associated with the computer system to interpolate between and extrapolate beyond the patient specific data points to obtain a reduced number of patient specific x, y, z coordinates that correspond to the nodes of the finite element analysis model, respectively, and assigning the reduced number of patient specific x, y, z coordinates to the various nodes respectively, and assigning the value of the external pressure to elements of the finite element analysis model corresponding to locations of the patient's eye to which the external pressure is applied in step (b);
(d) determining a value representing intraocular pressure in the patient's eye and assigning a strain value to each element;
(e) assigning initial values of the strain to each element, respectively, of the finite element analysis model;
(f) using the finite element analysis model, computing new values of the patient specific x, y, z coordinates at each of the nodes to simulate deformation of the cornea resulting from the external pressure and the intraocular pressure for the initial values of the strain;
(g) comparing the new values of the patient specific x, y, z coordinates computed in step (f) with the patient specific x, y, z coordinates recited in step (c);
(h) operating the processing device to modify values of the strain of the finite element analysis model, respectively, if the comparing of step (g) indicates a difference between the patient specific x, y, z coordinates obtained in step (c) and the patient specific x, y, z coordinates computed in step (f) exceeds a predetermined criteria;
(i) repeating steps (f) through (h) until final values of the strain are obtained;
(j) representing an insertion of an insert in the cornea, and thus a region of increased stiffness in the cornea, in the mathematical analysis model by assigning at least one of reduced values of the thickness and a reduced value of the modulus of elasticity to elements corresponding to the insertion of the insert in the cornea, respectively;
(k) using the finite element analysis model, computing new values of the patient specific x, y, z coordinates at each of the nodes to simulate deformation of the cornea resulting from the proposed insertion of the insert in the cornea;
(l) comparing the simulated deformation of the cornea with at least one preestablished vision objective for the patient's eye, said at least one pre-established vision objective being selected from the group consisting of visual acuity, duration of treatment, absence of side effects, low light vision, astigmatism, contrast and depth perception, to determine if the insertion of the insert in the cornea results in the vision objective being met; and
(m) if the vision objective is not met, modifying the proposed insertion of the insert in the cornea in the finite element analysis model and repeating steps (j) through (l) until the at least one pre-determined vision objective is met.

22. A computer-implemented method of simulating change of a cornea of patient specific patient's eye as a result of a proposed insertion of an insert in the cornea, the computer implemented method including the steps of;
(a) storing in a storage device operatively associated with a computer system used for the computer-implemented method, a finite element analysis model of a patient's eye, the finite element analysis model including a number of nodes, the connectivities of which define a plurality of elements;
(b) applying a known external pressure to the patient's eye and then measuring the topography of a portion of the patient's eye under the influence of the externally applied pressure using a topography measuring device to produce patient specific x, y, z coordinates for a number of patient specific data points of the surface of the patient's eye and then remapping the topography by backcalculating the data;
(c) operating a processing device associated with the computer system to interpolate between and extrapolate beyond the patient specific data points to obtain a reduced number of patient specific x, y, z coordinates that correspond to the nodes of the finite element analysis model, respectively, and assigning the reduced number of patient specific x, y, z coordinates to the various nodes respectively, and assigning the value of the external pressure to elements of the finite element analysis model corresponding to locations of the patient's eye to which the external pressure is applied in step (b);
(d) determining a value representing intraocular pressure in the patient's eye and assigning a strain value to each element;
(e) assigning initial values of the strain to each element, respectively, of the finite element analysis model;
(f) using the finite element analysis model, computing new values of the patient specific x, y, z coordinates at each of the nodes to simulate deformation of the cornea resulting from the external pressure and the intraocular pressure for the initial values of the strain;
(g) comparing the new values of the patient specific x, y, z coordinates computed in step (f) with the patient specific x, y, z coordinates recited in step (c);
(h) operating the processing device to modify values of the strain of the elements of the finite element analysis model respectively, if the comparing of step (g) indicates a difference between the patient specific x, y, z coordinates obtained in step (c) and the patient specific x, y, z coordinates computed in step (f) exceeds a predetermined criteria;
(i) repeating steps (f) through (h) until a final value of the strain is obtained;
(j) representing an insertion of an insert in the cornea, and thus a region of increased stiffness in the cornea, in the finite element analysis model, by shell modeling, by representing the thickness of the insert by changing the z coordinate of elements surrounding the insertion insert and representing the change in the corneal elasticity caused by a first insertion of an insert in the cornea by means of a plurality of nonlinear spring elements having load deflection curves based upon the at least one material property value determined in step (i) and insert thickness, each of the plurality of nonlinear spring elements connecting insert-bounding node to an adjacent node, respectively;
(k) using the finite element analysis model, computing new values of the patient specific x, y, z coordinates at each of the nodes to simulate deformation of the cornea resulting from the insertion of the insert in the cornea and the intraocular pressure;
(l) comparing the simulated deformation of the cornea with at least one preestablished vision objective for the patient's eye to determine if the insertion of the insert in the cornea results in the at least one vision objective being met; and
(m) if the vision objective is not met, modifying the insertion of the insert in the cornea in the finite element analysis model and repeating steps (j) through (l) until the vision objective is met.
